(19) United States
(12) Patent Application Publication
(10) Pub. No.: US 2025/0278236 A1
(43) Pub. Date: Sep. 4, 2025

(54) SOUND AND VIBRATION PLAYING METHOD AND APPARATUS

(71) Applicant: AAC ACOUSTIC TECHNOLOGIES (SHANGHAI) CO., LTD., Shanghai (CN)

(72) Inventors: Yajun Zheng, Shenzhen (CN); Yulei Zhang, Shenzhen (CN); Xiang Ding, Shenzhen (CN); Xiaojie Shao, Shenzhen (CN)

(21) Appl. No.: 17/915,510

(22) PCT Filed: Aug. 9, 2022
(86) PCT No.: PCT/CN2022/111135

§ 371 Date: May 23, 2025

(30) Foreign Application Priority Data
Jul. 21, 2022 (CN) 202210862335.9

(51) Int. Cl. G06F 3/16

(52) U.S. Cl. CPC G06F 3/165

(57) ABSTRACT

The present disclosure belongs to signal processing field, and provides sound and vibration playing method and apparatus. The method includes acquiring original audio signal A1 and original vibration signal V1 according to event response information; reading current system mode, and acquiring preset normalized parameter value a from state configuration file of current system mode; calculating power ratio of original audio signal A1 to original vibration signal V1 according to preset normalized parameter value a, and weighting original audio signal A1 and original vibration signal V1 according to power ratio to obtain to-be-executed signal; and outputting to-be-executed signal to be executed by an audio execution unit and a vibration execution unit. In the present disclosure, different sound-vibration power ratios are selected according to different system modes, and to-be-executed signals are generated according to actual hardware restrictions, to realize intelligent generation of different sound and vibration intensity in different system modes.

### TECHNICAL FIELD

The present disclosure relates to the technical field of signal processing, and in particular, to a sound and vibration playing method and apparatus.

### BACKGROUND

With the rapid development of science and technology, people's pursuit of quality of life is increasingly high. People have increasingly high requirements on multimedia audio-visual equipment, such as laptop computers and mobile phones, which is used as an important experience terminal device in daily life, especially on performance of a sound system thereof.

### Overview of the Application

### Technical Problem

A sound system in the related art for producing sound and vibration includes a signal processing module for generating sound and vibration signals and a driving module for driving a sound unit and a vibration unit. However, in the sound system in the related art, the sound and vibration signals are uniformly pushed to the driving module, and the units independently receive the corresponding sound and vibration signals and produce acoustic effects. No matching relationship exists between sound intensity and vibration intensity thereof, resulting in a poor correlation effect of sound and vibration of the sound system and affecting user experience.

Therefore, there is a need to provide a new sound and vibration playing method to solve the above problems.

### Solution for the Problem

### Technical Solution

### SUMMARY

The technical problem to be solved in the present disclosure is that the correlation effect produced during sound and vibration playing is poor and different sound and vibration intensity cannot be generated according to scenarios.

In order to solve the above technical problem, in a first aspect, the present disclosure provides a sound and vibration playing method, the method including the following steps:
acquiring an original audio signal A1 and an original vibration signal V1 according to event response information;
reading a current system mode, and acquiring a preset normalized parameter value a from a state configuration file of the current system mode;
calculating a power ratio of the original audio signal A1 to the original vibration signal V1 according to the preset normalized parameter value a, and weighting the original audio signal A1 and the original vibration signal V1 respectively according to the power ratio to obtain a to-be-executed signal; and
outputting the to-be-executed signal, the to-be-executed signal being executed respectively by an audio execution unit and a vibration execution unit.

As an improvement, the step of calculating a power ratio of the original audio signal A1 to the original vibration signal V1 according to the preset normalized parameter value a, and weighting the original audio signal A1 and the original vibration signal V1 respectively according to the power ratio to obtain a to-be-executed signal specifically includes:
judging whether the audio execution unit and the vibration execution unit each have an independent driver, and if yes:
analytically calculating the preset normalized parameter value a to obtain the power ratio of the original audio signal A1 to the original vibration signal V1; and
weighting the original audio signal A1 and the original vibration signal V1 respectively according to the power ratio to obtain the to-be-executed signal, the to-be-executed signal being M1 and including a first audio signal A2 executed by the audio execution unit to produce sound and a first vibration signal V2 executed by the vibration execution unit to produce vibration.

As an improvement, the step of calculating a power ratio of the original audio signal A1 to the original vibration signal V1 according to the preset normalized parameter value a, and weighting the original audio signal A1 and the original vibration signal V1 respectively according to the power ratio to obtain a to-be-executed signal specifically includes:
judging whether the audio execution unit and the vibration execution unit each have an independent driver, and if no:
first analytically calculating the preset normalized parameter value a to obtain the power ratio of the original audio signal A1 to the original vibration signal V1;
then weighting the original audio signal A1 and the original vibration signal V1 respectively according to the power ratio to obtain the to-be-executed signal, the to-be-executed signal including a first audio signal A2 and a first vibration signal V2;
filtering the first audio signal A2 and the first vibration signal V2 respectively according to a preset cutoff frequency to obtain a second audio signal A3 after filtering and a second vibration signal V3 after filtering; and
adding the first audio signal A3 and the first vibration signal V3 to obtain the to-be-executed signal, the to-be-executed signal being M2, M2=A3+V3.

As an improvement, the step of filtering the first audio signal A2 and the first vibration signal V2 respectively according to a preset cutoff frequency to obtain a second audio signal A3 after filtering and a second vibration signal V3 after filtering specifically includes:
performing low-pass filtering on the first audio signal A2 at a cutoff frequency which is the preset cutoff frequency to obtain the second audio signal A3, and performing high-pass filtering on the first vibration signal V2 at a cutoff frequency which is the preset cutoff frequency to obtain the second vibration signal V3.

As an improvement, the to-be-executed signal M2 is outputted to an execution circuit, the execution circuit including a driver, a frequency dividing circuit, and the audio execution unit and the vibration execution unit respectively connected to two outputs of the frequency dividing circuit that are sequentially connected; the frequency dividing circuit splitting, by frequency division, the to-be-executed signal M2 after being driven by the driver to obtain the second audio signal A3 and the second vibration signal V3 after driving, the audio execution unit being configured to execute the second audio signal A3 to realize sound production, the vibration execution unit being configured to execute the second vibration signal V3 to realize vibration.

As an improvement, the first audio signal A2 and the first vibration signal V2 satisfy the following relations respectively:

$$A 2 = A 1 \times a \times 100 ; and$$

$$V2 = V 1 \times ( 1 - a ) \times 100 .$$

As an improvement, the preset cutoff frequency is directly proportional to an expectation of a vibration frequency response.

In a second aspect, the present disclosure provides a sound and vibration playing apparatus, the playing apparatus including:
an event response module configured to acquire an original audio signal A1 and an original vibration signal V1 according to event response information;
a system reading module configured to read a current system mode, and acquire a preset normalized parameter value a from a state configuration file of the current system mode;
a signal processing module configured to calculate a power ratio of the original audio signal A1 to the original vibration signal V1 according to the preset normalized parameter value a, and weight the original audio signal A1 and the original vibration signal V1 respectively according to the power ratio to obtain a to-be-executed signal; and
a signal output module configured to output the to-be-executed signal, the to-be-executed signal being executed respectively by an audio execution unit and a vibration execution unit.

In a third aspect, the present disclosure provides a computer device, including: a memory, a processor, and a computer program stored on the memory and runnable on the processor, the processor, when executing the computer program, implementing steps in the sound and vibration playing method as described in any one of the above embodiments.

In a fourth aspect, the present disclosure provides a computer-readable storage medium, wherein the computer-readable storage medium stores a computer program, the computer program, when executed by a processor, causing the processor to implementing steps in the sound and vibration playing method as described in any one of the above embodiments.

### Beneficial Effects of the Application

### Beneficial Effects

Compared with the related art, in the sound and vibration playing method in the present disclosure, firstly, a response is generated according to event trigger, and normalized parameter values are read from the system; then, different sound-vibration power ratios are selected according to modes set in different sound systems, and signal processing is performed according to actual hardware restrictions to generate output signals, so as to realize intelligent generation of different sound and vibration intensity in different system modes.

### BRIEF DESCRIPTION OF DRAWINGS

### Description of Drawings

In order to more clearly illustrate the technical solutions in embodiments of the present disclosure, the accompanying drawings used in the description of the embodiments will be briefly introduced below. It is apparent that, the accompanying drawings in the following description are only some embodiments of the present disclosure, and other drawings can be obtained by those of ordinary skill in the art from the provided drawings without creative efforts.

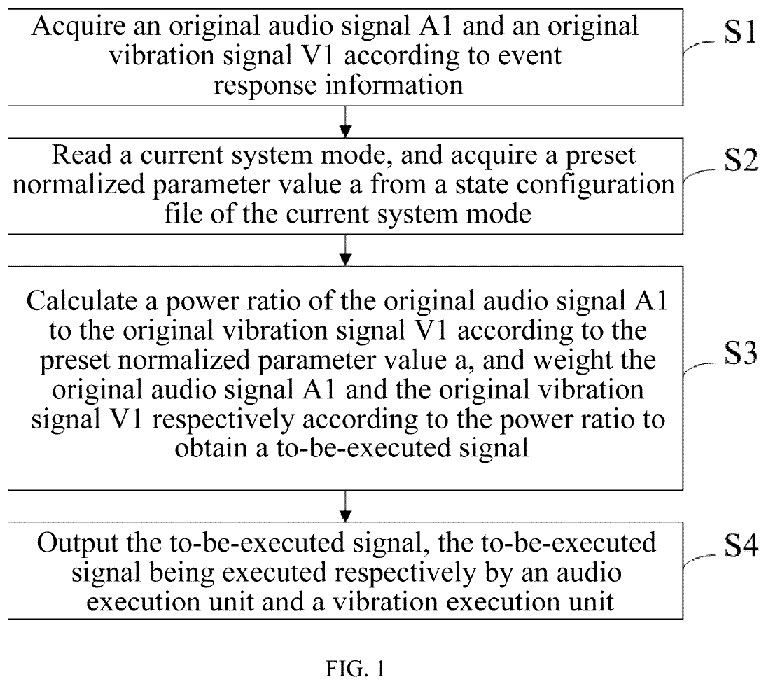

FIG. 1 is a schematic flowchart of steps of a sound and vibration playing method according to an embodiment of the present disclosure;

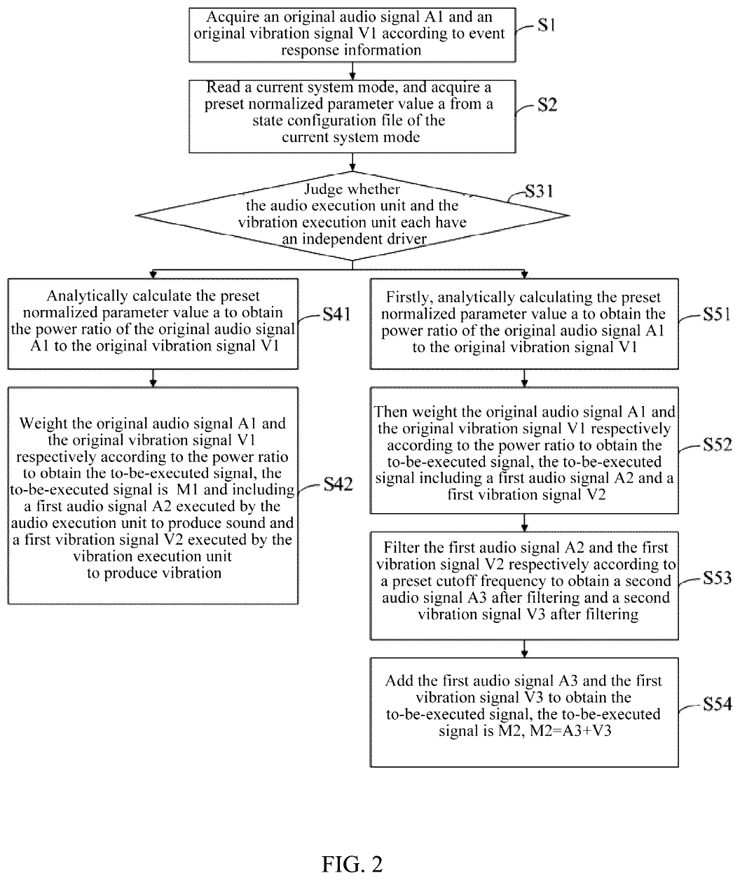

FIG. 2 is a flow block diagram after judgment is generated in step S3 in the sound and vibration playing method according to an embodiment of the present disclosure;

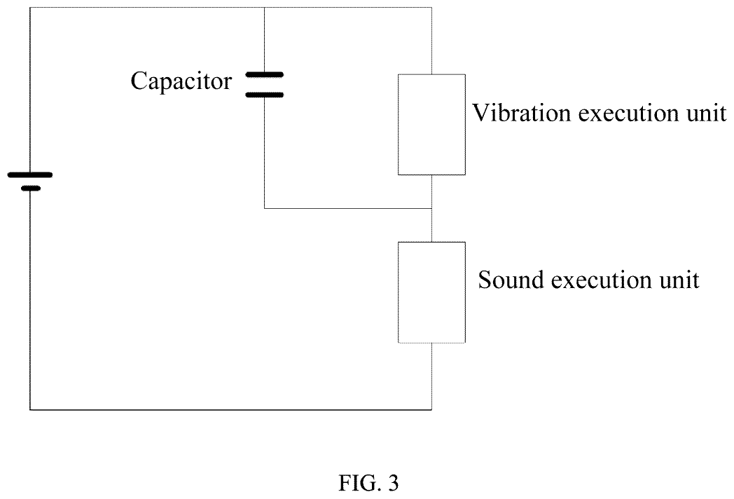

FIG. 3 is a schematic diagram of a frequency dividing circuit for outputting an output signal M2 according to an embodiment of the present disclosure;

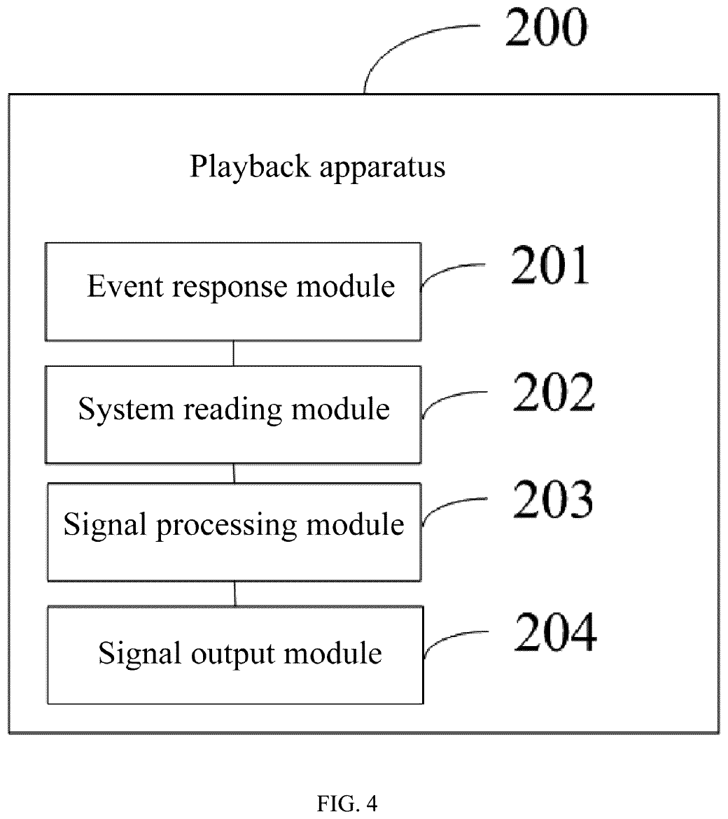

FIG. 4 is a schematic structural diagram of a playing apparatus 200 according to an embodiment of the present disclosure; and

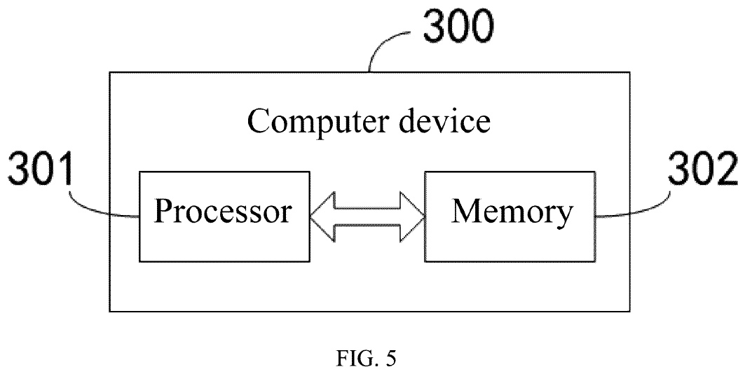

FIG. 5 is a schematic structural diagram of a computer device according to an embodiment of the present disclosure.

### DESCRIPTION OF EMBODIMENTS

### Best Examples of Carrying out the Application

### Best Implementation Mode of the Application

The technical solutions in the embodiments of the present disclosure will be described clearly and completely below with reference to the accompanying drawings in the embodiments of the present disclosure. Apparently, the described embodiments are merely some of rather than all of the embodiments of the present disclosure. All other embodiments acquired by those of ordinary skill in the art without creative efforts based on the embodiments of the present disclosure shall fall within the protection scope of the present disclosure.

Referring to FIG. 1, FIG. 1 is a schematic flowchart of steps of a sound and vibration playing method according to an embodiment of the present disclosure. The playing method includes the following steps.

In S1, an original audio signal A1 and an original vibration signal V1 are acquired according to event response information.

For example, in the embodiment of the present disclosure, an event response scenario is that a user clicks on an audio file, and the event response information is a sound-vibration response signal generated according to the audio file. The response signal is divided into the original audio signal A1 and the original vibration signal V1 according to different signal types.

In S2, a current system mode is read, and a preset normalized parameter value a is acquired from a state configuration file of the current system mode.

Specifically, in the embodiment of the present disclosure, the state configuration file is stored in a sound system for playing back the audio file. System modes in a variety of scenarios are preset in the sound system. For example, an equalization mode and a quiet mode are preset in the sound system. For the preset normalized parameter value a, the preset normalized parameter value a in the equalization mode is 0.7, and the preset normalized parameter value a in the quiet mode is 0.3.

In S3, a power ratio of the original audio signal A1 to the original vibration signal V1 is calculated according to the preset normalized parameter value a, and the original audio signal A1 and the original vibration signal V1 are weighted respectively according to the power ratio to obtain a to-be-executed signal.

Furthermore, referring to FIG. 2, FIG. 2 is a flow block diagram after judgment is generated in step S3 in the sound and vibration playing method according to an embodiment of the present disclosure. The step of calculating a power ratio of the original audio signal A1 to the original vibration signal V1 according to the preset normalized parameter value a, and weighting the original audio signal A1 and the original vibration signal V1 respectively according to the power ratio to obtain a to-be-executed signal specifically includes the following steps.

In S31, it is judged whether the audio execution unit and the vibration execution unit each have an independent driver, and if yes:

In S41, the preset normalized parameter value a is analytically calculated to obtain the power ratio of the original audio signal A1 to the original vibration signal V1.

As an improvement, the power ratio is a power mapping relationship generated according to the preset normalized parameter value a. In the power mapping relationship, a ratio for sound and vibration is a/(1-a). In addition, for example, in a preset scenario mode, the sound vibration power ratio may also be determined using another preset mapping relationship. Taking the equalization mode and the quiet mode as an example, in the equalization mode, 70 percent of the power is allocated to sound output and the remaining 30 percent is allocated to vibration output, while in the quite mode, 100 percent of the power is allocated to the vibration output, and no power is allocated to the unit that outputs sound, so as to achieve intelligent sound and vibration playing modes in different usage scenarios.

In S42, the original audio signal A1 and the original vibration signal V1 are weighted respectively according to the power ratio to obtain the to-be-executed signal, the to-be-executed signal being M1 and including a first audio signal A2 executed by the audio execution unit to produce sound and a first vibration signal V2 executed by the vibration execution unit to produce vibration.

The first audio signal A2 and the first vibration signal V2 satisfy the following relations respectively:

$$A 2 = A 1 \times a \times 100 ; and$$

$$V 2 = V 1 \times ( 1 - a ) \times 100 .$$

In another embodiment according to the present disclosure, when it is judging whether the audio execution unit and the vibration execution unit each have an independent driver in step S31, if no:

In S51, first, the preset normalized parameter value a is analytically calculated to obtain the power ratio of the original audio signal A1 to the original vibration signal V1.

In S52, then, the original audio signal A1 and the original vibration signal V1 are weighted respectively according to the power ratio to obtain the to-be-executed signal, the to-be-executed signal including a first audio signal A2 and a first vibration signal V2.

In S53, the first audio signal A2 and the first vibration signal V2 are filtered respectively according to a preset cutoff frequency to obtain a second audio signal A3 after filtering and a second vibration signal V3 after filtering.

In S54, the first audio signal A3 and the first vibration signal V3 are added to obtain the to-be-executed signal, the to-be-executed signal being M2, M2=A3+V3.

In step S53, the step of filtering the first audio signal A2 and the first vibration signal V2 respectively according to a preset cutoff frequency to obtain a second audio signal A3 after filtering and a second vibration signal V3 after filtering specifically includes:
performing low-pass filtering on the first audio signal A2 at a cutoff frequency which is the preset cutoff frequency to obtain the second audio signal A3, and performing high-pass filtering on the first vibration signal V2 at a cutoff frequency which is the preset cutoff frequency to obtain the second vibration signal V3.

In S4, the to-be-executed signal is outputted, the to-be-executed signal being executed respectively by an audio execution unit and a vibration execution unit.

As for the two implementations expressed differently in step S31 due to whether the audio execution unit and the vibration execution unit each have an independent driver, the difference lies in different playing carriers. In steps S41-S42, the to-be-executed signal M1 includes two signals, namely, the second audio signal A2 and the second vibration signal V2, so the signals are required only to be transmitted to the corresponding drivers. However, in steps S51-S524, the to-be-executed signal M2 is a signal resulted from addition of two signals, which is individually driven for sound and vibration playing. In this case, the to-be-executed signal M2 of one signal is required to be filtered, so as to separate signals in different frequency bands. For example, in one possible embodiment, a frequency dividing circuit for outputting the to-be-executed signal M2 is shown in FIG. 3. A signal splitting principle of the frequency dividing circuit is opposite to the filtering, preprocessing, and adding processes of the to-be-executed signal M2. In the implementation of the frequency dividing circuit, a capacitor is fixed to two ends of the vibration execution unit in parallel, and then connected in series with the audio execution unit. Therefore, a high-frequency signal does not pass through the vibration execution unit, but directly enters the sound execution unit through the capacitor, and a low-frequency signal can enter the vibration execution unit.

As an improvement, the preset cutoff frequency is directly proportional to an expectation of a vibration frequency response. The preset cutoff frequency may be set according to an actual requirement of a sound and vibration frequency response. If a vibration frequency expects a wider frequency response, the preset cutoff frequency is set to a higher value. Otherwise, the preset cutoff frequency is set to a lower value.

Compared with the related art, in the sound and vibration playing method in the present disclosure, firstly, a response is generated according to event trigger, and normalized parameter values are read from the system; then, different sound-vibration power ratios are selected according to modes set in different sound systems, and signal processing is performed according to actual hardware restrictions to generate output signals, so as to realize intelligent generation of different sound and vibration intensity in different system modes.

An embodiment of the present disclosure further provides a sound and vibration playing apparatus. Referring to FIG. 4, FIG. 4 is a schematic structural diagram of a playing apparatus 200 according to an embodiment of the present disclosure. The playing apparatus 200 includes:
an event response module 201 configured to acquire an original audio signal A1 and an original vibration signal V1 according to event response information;
a system reading module 202 configured to read a current system mode, and acquire a preset normalized parameter value a from a state configuration file of the current system mode;
a signal processing module 203 configured to calculate a power ratio of the original audio signal A1 to the original vibration signal V1 according to the preset normalized parameter value a, and weight the original audio signal A1 and the original vibration signal V1 respectively according to the power ratio to obtain a to-be-executed signal; and
a signal output module 204 configured to output the to-be-executed signal, the to-be-executed signal being executed respectively by an audio execution unit and a vibration execution unit.

An embodiment of the present disclosure further provides a computer device. Referring to FIG. 5, FIG. 5 is a schematic structural diagram of a computer device according to an embodiment of the present disclosure. The computer device 300 includes: a processor 301, a memory 302, and a computer program stored on the memory 302 and runnable on the processor 301.

Referring to FIG. 1, the processor 301 calls the computer program stored in the memory 302 to implement steps in the sound and vibration playing method in the above embodiment when executing the computer program, including:
S1. acquiring an original audio signal A1 and an original vibration signal V1 according to event response information;
S2. reading a current system mode, and acquiring a preset normalized parameter value a from a state configuration file of the current system mode;
S3. calculating a power ratio of the original audio signal A1 to the original vibration signal V1 according to the preset normalized parameter value a, and weighting the original audio signal A1 and the original vibration signal V1 respectively according to the power ratio to obtain a to-be-executed signal; and
S4. outputting the to-be-executed signal, the to-be-executed signal being executed respectively by an audio execution unit and a vibration execution unit.

As an improvement, the step of calculating a power ratio of the original audio signal A1 to the original vibration signal V1 according to the preset normalized parameter value a, and weighting the original audio signal A1 and the original vibration signal V1 respectively according to the power ratio to obtain a to-be-executed signal specifically includes:
judging whether the audio execution unit and the vibration execution unit each have an independent driver, and if yes:
analytically calculating the preset normalized parameter value a to obtain the power ratio of the original audio signal A1 to the original vibration signal V1; and
weighting the original audio signal A1 and the original vibration signal V1 respectively according to the power ratio to obtain the to-be-executed signal, the to-be-executed signal being M1 and including a first audio signal A2 executed by the audio execution unit to produce sound and a first vibration signal V2 executed by the vibration execution unit to produce vibration.

As an improvement, the step of calculating a power ratio of the original audio signal A1 to the original vibration signal V1 according to the preset normalized parameter value a, and weighting the original audio signal A1 and the original vibration signal V1 respectively according to the power ratio to obtain a to-be-executed signal specifically includes:
judging whether the audio execution unit and the vibration execution unit each have an independent driver, and if no:
first analytically calculating the preset normalized parameter value a to obtain the power ratio of the original audio signal A1 to the original vibration signal V1;
then weighting the original audio signal A1 and the original vibration signal V1 respectively according to the power ratio to obtain the to-be-executed signal, the to-be-executed signal including a first audio signal A2 and a first vibration signal V2;
filtering the first audio signal A2 and the first vibration signal V2 respectively according to a preset cutoff frequency to obtain a second audio signal A3 after filtering and a second vibration signal V3 after filtering; and
adding the first audio signal A3 and the first vibration signal V3 to obtain the to-be-executed signal, the to-be-executed signal being M2, M2=A3+V3.

As an improvement, the step of filtering the first audio signal A2 and the first vibration signal V2 respectively according to a preset cutoff frequency to obtain a second audio signal A3 after filtering and a second vibration signal V3 after filtering specifically includes:
performing low-pass filtering on the first audio signal A2 at a cutoff frequency which is the preset cutoff frequency to obtain the second audio signal A3, and performing high-pass filtering on the first vibration signal V2 at a cutoff frequency which is the preset cutoff frequency to obtain the second vibration signal V3.

As an improvement, the to-be-executed signal M2 is outputted to an execution circuit, the execution circuit including a driver, a frequency dividing circuit, and the audio execution unit and the vibration execution unit respectively connected to two outputs of the frequency dividing circuit that are sequentially connected; the frequency dividing circuit splitting, by frequency division, the to-be-executed signal M2 after being driven by the driver to obtain the second audio signal A3 and the second vibration signal V3 after driving, the audio execution unit being configured to execute the second audio signal A3 to realize sound production, the vibration execution unit being configured to execute the second vibration signal V3 to realize vibration.

As an improvement, the first audio signal A2 and the first vibration signal V2 satisfy the following relations respectively:

$$A 2 = A 1 \times a \times 100 ; and$$

$$V 2 = V 1 \times ( 1 - a ) \times 100 .$$

As an improvement, the preset cutoff frequency is directly proportional to an expectation of a vibration frequency response.

The computer device 300 according to the embodiment of the present disclosure can implement the steps in the sound and vibration playing method in the above embodiment, and can achieve the same technical effect. Refer to the description in the above embodiment. Details are not described herein.

An embodiment of the present disclosure further provides a computer-readable storage medium. The computer-readable storage medium stores a computer program. The computer program, when executed by a processor, causes the processor to implementing various processes and steps in the sound and vibration playing method according to the embodiment of the present disclosure, and can achieve the same technical effect. Details are not described herein so as to avoid repetition.

The above are only embodiments of the present disclosure. It should be pointed out herein that those of ordinary skill in the art may further make improvements without departing from the inventive concept of the present disclosure. The improvements all fall within the protection scope of the present disclosure.

1. A sound and vibration playing method, comprising:
acquiring an original audio signal A1 and an original vibration signal V1 according to event response information;
reading a current system mode, and acquiring a preset normalized parameter value a from a state configuration file of the current system mode;
calculating a power ratio of the original audio signal A1 to the original vibration signal V1 according to the preset normalized parameter value a, and weighting the original audio signal A1 and the original vibration signal V1 respectively according to the power ratio to obtain a to-be-executed signal; and
outputting the to-be-executed signal, wherein the to-be-executed signal is executed respectively by an audio execution unit and a vibration execution unit.

2. The sound and vibration playing method as described in claim 1, wherein the calculating a power ratio of the original audio signal A1 to the original vibration signal V1 according to the preset normalized parameter value a, and weighting the original audio signal A1 and the original vibration signal V1 respectively according to the power ratio to obtain a to-be-executed signal comprises:
judging whether each of the audio execution unit and the vibration execution unit has an independent driver, and if yes:
analytically calculating the preset normalized parameter value a to obtain the power ratio of the original audio signal A1 to the original vibration signal V1; and
weighting the original audio signal A1 and the original vibration signal V1 respectively according to the power ratio to obtain the to-be-executed signal, wherein the to-be-executed signal is M1 which comprises a first audio signal A2 executed by the audio execution unit to produce sound and a first vibration signal V2 executed by the vibration execution unit to produce vibration.

3. The sound and vibration playing method as described in claim 1, wherein the calculating a power ratio of the original audio signal A1 to the original vibration signal V1 according to the preset normalized parameter value a, and weighting the original audio signal A1 and the original vibration signal V1 respectively according to the power ratio to obtain a to-be-executed signal comprises:
judging whether each of the audio execution unit and the vibration execution unit has an independent driver, and if no:
at first, analytically calculating the preset normalized parameter value a to obtain the power ratio of the original audio signal A1 to the original vibration signal V1;
then weighting the original audio signal A1 and the original vibration signal V1 respectively according to the power ratio to obtain the to-be-executed signal, wherein the to-be-executed signal comprises a first audio signal A2 and a first vibration signal V2;
filtering the first audio signal A2 and the first vibration signal V2 respectively according to a preset cutoff frequency to obtain a second audio signal A3 after filtering and a second vibration signal V3 after filtering; and
adding the first audio signal A3 and the first vibration signal V3 to obtain the to-be-executed signal M2, where M2=A3+V3.

4. The sound and vibration playing method as described in claim 3, wherein the filtering the first audio signal A2 and the first vibration signal V2 respectively according to a preset cutoff frequency to obtain a second audio signal A3 after filtering and a second vibration signal V3 after filtering comprises:
performing low-pass filtering on the first audio signal A2 at a cutoff frequency which is the preset cutoff frequency to obtain the second audio signal A3, and performing high-pass filtering on the first vibration signal V2 at a cutoff frequency which is the preset cutoff frequency to obtain the second vibration signal V3.

5. The sound and vibration playing method according to claim 3, wherein the to-be-executed signal M2 is outputted to an execution circuit, the execution circuit comprises a driver, a frequency dividing circuit, and the audio execution unit and the vibration execution unit respectively connected to two outputs of the frequency dividing circuit that are sequentially connected; the frequency dividing circuit splits, by frequency division, the to-be-executed signal M2 after being driven by the driver to obtain the second audio signal A3 and the second vibration signal V3 after driving,
the audio execution unit is configured to execute the second audio signal A3 to realize sound production, the vibration execution unit is configured to execute the second vibration signal V3 to realize vibration.

6. The sound and vibration playing method as described in claim 2, wherein the first audio signal A2 and the first vibration signal V2 satisfy following relations respectively:
$$A 2 = A 1 \times a \times 100 ; and$$
$$V 2 = V 1 \times ( 1 - a ) \times 100 .$$

7. The sound and vibration playing method as described in claim 3, wherein the preset cutoff frequency is directly proportional to an expectation of a vibration frequency response.

8. A sound and vibration playing apparatus, wherein the playing apparatus comprises:
an event response module, configured to acquire an original audio signal A1 and an original vibration signal V1 according to event response information;
a system reading module, configured to read a current system mode, and acquire a preset normalized parameter value a from a state configuration file of the current system mode;
a signal processing module, configured to calculate a power ratio of the original audio signal A1 to the original vibration signal V1 according to the preset normalized parameter value a, and weight the original audio signal A1 and the original vibration signal V1 respectively according to the power ratio to obtain a to-be-executed signal; and
a signal output module, configured to output the to-be-executed signal, wherein the to-be-executed signal is executed respectively by an audio execution unit and a vibration execution unit.

9. A computer device, comprising: a memory, a processor, and a computer program stored on the memory and runnable on the processor, wherein
the processor, when executing the computer program, implements steps in the sound and vibration playing method as described in claim 1.

10. (canceled)
